(19) United States
(12) Patent Application Publication
(10) Pub. No.: US 2014/0280524 A1
(43) Pub. Date: Sep. 18, 2014

(54) Social Network Based Filtering of User Generated Content

(71) Applicant: QUICK TECHNOLOGIES, LLC, Boston, MA (US)

(72) Inventors: Jeremy J. Paradise, Boston, MA (US); Ilan Dee, Waltham, MA (US); Doug A. Brenhouse, Boston, MA (US)

(73) Assignee: QUICK TECHNOLOGIES, LLC, Boston, MA (US)

(21) Appl. No.: 13/795,097

(22) Filed: Mar. 12, 2013

(51) Int. Cl. H04L 29/08

(52) U.S. Cl. CPC H04L 67/22
USPC 709/204

(57) ABSTRACT

Data characterizing a user and a plurality of authors is received at a server and each author having authored user-generated content. The plurality of authors is filtered, using the server, based on data characterizing one or more relationships between the user and each author. Data characterizing the filtered plurality of authors is provided using the server. Related apparatus, systems, techniques, and articles are also described.

### TECHNICAL FIELD

The subject matter described herein relates to filtering user-generated content based on social network and relationship information.

### BACKGROUND

User-generated content (UGC) covers a range of media content created or generated by a user and published using some form of digital media technology. All digital media technologies are included, such as question-answer databases, digital video, blogging, podcasting, forums, review-sites, social networking, mobile phone photography, wikis, etc. Sometimes UGC can constitute only a portion of a website. For example, there are sites where administrators prepare the majority of content, but regular users of the site submit numerous user reviews of for sale products. Users generally publish UGC in some form, such as on a publicly accessible website or on a page on a social networking site only accessible to a select group of people (e.g., fellow university students, friends, etc.).

Review of any kind of content (UGC or non-UGC) by users (thereby creating UGC), can include written reviews and rating reviews. Written reviews can include a written description and ranking reviews can include a number value (for example, 3 out of 5). Rankings can include multiple rankings in different categories and can include binary rankings (for example, “liking” content or adding the content to a “favorites” list). Users interested in consuming the content can read the reviews as a form of trusted third-party advice. Consumption of the content can include, for example, one or more of downloading the content, reading the content, purchasing the content, listening to the content, etc. The content can include, for example, purchasing products (goods or services) for sale on an online marketplace (e.g., Quickuickable Marketplace™, Amazon.com™, Ebay®, Craigslist™, etc.), news articles, blog posts, videos, music, etc.

However, it can be difficult for a user interested in consuming the content to differentiate between conflicting reviews. If content has multiple reviews, some good and some bad, it can be difficult to know which review to rely upon. Further, people often have differing likes and needs (e.g., different tastes) which can lead to different opinions regarding the content.

### SUMMARY

In one aspect, data characterizing a user and a plurality of authors is received at a server, each author having associated authored user-generated content. The plurality of authors is filtered, using the server, based on data characterizing one or more relationships between the user and each author. Data characterizing the filtered plurality of authors is provided using the server.

In another aspect, data characterizing a plurality of product inquiries is received at a server. Each inquiry is associated with a user. The received data is filtered using a server and using social network data associated with a viewing user to create a subset of the plurality of product inquiries relevant to the viewing user. The relevant subset is provided using the server.

One or more of the following features can be included. For example, filtering can include prioritizing the plurality of authors. The data characterizing relationships can include links between the author and the user on an online social network. The data characterizing relationships can include a type of link between the author and the user on an online social network. The filtering can be based on a degree of social connection between the user and each of the plurality of authors. The filtering can be based on a number of shared social connections. Filtering can includes determining a subset of authors. The subset of authors can be ordered.

The user-generated content can be associated with content to be consumed by the user. The user-generated content can be a content review. The content review can include at least one of: a rating and a written review. The review can be a product review.

The filtering of each author can be based on a measure of the respective author's ability to make discerning judgments of a product. The measure of each author's ability to make discerning judgments of a product can be based on a measure of a number of products previously purchased by the user that the respective author has positively reviewed. The measure of each author's ability to make discerning judgments of a product can be based on an occurrence of purchase of products by one or more individuals with an explicit relationship on a social network to the respective author. The measure of each author's ability to make discerning judgments of a product can be determined by an occurrence of inquiries of previously reviewed products by individuals connected on a social network to the respective author.

The respective author can have reviewed the product prior to the one or more individuals' purchase of the product. Each product inquiry can include a date and time the associated user requested product information. Requesting product information can include scanning a barcode of the product using a mobile device. Each product inquiry can include a date and time the associated user purchased the product. Each product inquiry can include a date and time the associated user reviewed the product.

Providing can include at least one of: displaying, presenting, transmitting, processing, and persisting.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the current subject matter can present a user with a subset of UGC taken from a plurality of UGC, the subset being more relevant to the user than entire plurality of UGC. The current subject matter allows a user to view content reviews that are the most relevant to the user. Further, the current subject matter provides a measure of other individual's ability to make discerning judgments about products. For example, if a friend has a great taste in music, the current subject matter can filter that friend's review for a specific content from a plurality of content reviews. Rather than having to rely on unknown or anonymous third party reviews to decide whether to consume the content, a user can rely on reviews made by individuals known to the user. This provides an improved consumer experience.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method of filtering UGC based on social network information;

FIG. 2 is a process flow diagram illustrating a method of filtering product inquiries based on social network data; and

FIG. 3 is an example user interface presenting an offer for sale of a product and corresponding filtered reviews.

### DETAILED DESCRIPTION

FIG. 1 is a process flow diagram 100 illustrating a method of filtering UGC based on social network information. At 110, a server or other computing device receives data characterizing a user and a plurality of authors of UGC. The UGC can be included in the received data. At 120, the server filters the authors based on social network information such as relationships between the user and each of the authors. The filtering can include determining a subset of received authors, prioritizing the received authors, or both. The filtering can be implemented in software by, for example, a higher-order function that processes a data structure (such as a list) in some order to produce a new data structure containing elements of the original data structure for which a given predicate returns the Boolean value true. The new data structure can be ordered according to criterion.

A social network is an online service, platform, or site that focuses on facilitating the building of social networks or social relations among people. The people can share, for example, interests, activities, backgrounds, or real-life connections. A social network service consists of a representation of each user (often a profile), his/her social links, and a variety of additional services. Most social network services are web-based and provide means for users to interact over the Internet, such as e-mail and instant messaging. Online communities can be social networks. Social networking sites allow users to share ideas, activities, events, and interests within their individual networks.

The social network information can include explicit links between each author and the user on an online social network. For example, the server can base the filtering on information from a social network like Facebook® (i.e., the user and the author are “friends”), Google+® or LinkedIn®. The social network information can include the type of explicit link (e.g., the user and the author are “friends,” “good friends,” “colleagues,” etc.). For example, the filtering can filter out all author's who are not linked with the user, or all authors who are not “good friends.” The server can filter based on a degree of social connection between the user and each author (e.g., friends of friends, or member of specific ‘circles’) and/or a measure of social closeness such as a number of shared connections (the number of relationships that are common to both the user and each author).

UGC can be associated with other content. The content can be UGC or non-UGC. For example, the UGC can be a product review, and the content can be a posting of an offer for sale of the product on an online market or in a physical store. The review can include a rating and/or a written review. The rating can include a number value (for example, 3 out of 5) and can include binary rankings. For example, “liking” content or adding the content to a “favorites” list or approving the content would be a binary ranking Posting a link to content on a social network website is a form of approval (the link is the UGC and the link points to the content). Other reviews are possible.

The server can filter the authors based on a measure of each author's ability to make discerning judgments of content. This measure can be determined by correlating actions of the author with actions of other individuals. For example, the measure (or “taste score”) can be measured by determining a number of times content an author has previously consumed and reviewed (i.e., generated a UGC review) has been consumed or purchased by people connected to the author on a linked social network. The more people (connected to the author) who have consumed the content, the higher the measure of that author's ability to make discerning judgments. The measuring can include determining a number of times content an author has previously consumed and positively reviewed is also positively reviewed by someone connected on a social network to the author.

The measure of an author's ability to make discerning judgments of content can be specific to a user. For example, the measuring can include determining a number of times the user has viewed the author's reviews and include determining a number of times the user has consumed the content reviewed by the author. When the content is a product, the viewing of the reviews can include scanning a bar code on the product using a mobile device to access the reviews of the product. The measure of an author's ability to make discerning judgments of content can be specific to a type of product.

At 130, the server provides the filtered (i.e. subset of and/or prioritized set of) authors. The providing can include displaying, presenting, transmitting, processing, and persisting. The server can provide filtered authors along with the author's respective UGC to the user. When the filtering includes prioritizing the authors, the server can provide the UGC to the user with the same priority as the authorship.

For example, using the current subject matter, a user can view a product on an online market and be presented with highly relevant reviews of the product. For example, if the user is viewing an offer for sale of a soccer ball, any reviews authored by friends on a social network can be presented alone or prioritized above other less-relevant reviews. Additionally, if there are multiple reviews by friends, priority can be determined by other factors. In the above example, a friend who is also a teammate on a soccer team could be prioritized over other friends. Additionally, friends who have a history of making discerning judgments regarding products can be prioritized. Knowing that a friend purchased the product and reviewed it positively is more relevant and trustworthy than a review by an anonymous or author unknown to the user.

FIG. 2 is a process flow diagram 200 illustrating a method of filtering product inquiries based on social network data. At 210, a server receives data characterizing product inquiries. A product inquiry is a request for information regarding a product. A product inquiry can include an individual scanning a bar code on the product using a mobile device to access the information regarding the product. The inquiry can include viewing an offer for sale of the product on an online marketplace. The received data can further include a date, time, and user associated with each inquiry. The inquiry can comprise a purchase of the product.

At 220, the server filters the received data using social network data associated with a viewing user to create a relevant subset of inquiries. The server can filter inquiries based on direct or indirect links on a social network. The server can filter inquiries based on the date and time of the inquiries. The server can filter inquires based on the total number of inquiries. The filtering can include determining a subset of the received inquiries.

At 230, the server provides the relevant subset. The server can provide the relevant subset for displaying, presenting, transmitting, processing, persisting, etc. The server can provide the relevant subset to the viewing user.

FIG. 3 is an example user interface 300 presenting an offer for sale of a product and filtered reviews. The user interface 300 conveys an offer for sale of a widget (i.e. product/content). Offer panel 305 presents a title of the product, a picture, a product price, a time left on the offer, and a “Buy Now” push button (in this example, no picture is provided). Description panel 310 presents a description of the product. Product review panel 315 presents reviews that are relevant to a viewing user. At 320, the product review panel 315 presents a summary of the reviews. In this example, 28 individuals (i.e., authors) have generated reviews of the widget. Additionally, the product review panel 315 presents a description of the number of friends (of the viewing user) who have previously purchased a widget. In this example, seven of the viewing user's friends have previously purchased the widget. Further, the product review panel 315 presents a number of friends (of the viewing user) who have viewed the offer. In this example, fifteen friends have previously viewed the offer for sale of the widget. At 325, the product review panel 315 presents the most relevant review. In this example, a first friend's review, “Joe Goodtaste,” is a positive review. A measure of the first friend's ability to make discerning judgments of products is shown at 330 (i.e. “taste score”). A higher score implies a greater ability to make discerning judgments. At 335, the product review panel 315 presents the first friend's rating review and at 340, presents the written review.

At 345, product review panel 315 presents a second relevant review. In this example, a second friend's review, “Jane Connoiseur,” is also a positive review. As with the first friend's review, the product review panel 315 presents a “taste score,” rating review, and written review. At 350, product review panel 315 presents a pushbutton to display to the viewing user all product reviews (e.g., the unfiltered reviews), and at 355, the product review panel 315 presents a pushbutton to display to the viewing user a list of friends who have previously viewed, purchased, and/or reviewed the offer.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer (e.g., tablet, laptop, smart phone, etc.) having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input (e.g., touch screen).

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method comprising:
receiving, at a server, data characterizing a user and a plurality of authors, each author having associated authored user-generated content;
filtering, using the server, the plurality of authors based on data characterizing one or more relationships between the user and each author; and
providing, using the server, data characterizing the filtered plurality of authors;
wherein the server comprises at least one computing system having at least one data processor.

2. The computer-implemented method of claim 1, wherein filtering includes prioritizing the plurality of authors.

3. The computer-implemented method of claim 1, wherein the data characterizing relationships includes links between the author and the user on an online social network.

4. The computer-implemented method of claim 1, wherein the data characterizing relationships includes a type of link between the author and the user on an online social network.

5. The computer-implemented method of claim 1, wherein the filtering is based on a degree of social connection between the user and each of the plurality of authors.

6. The computer-implemented method of claim 1, wherein the filtering is based on a number of shared social connections.

7. The computer-implemented method of claim 1, wherein the user-generated content is associated with content to be consumed by the user.

8. The computer-implemented method of claim 1, wherein the user-generated content is a content review.

9. The computer-implemented method of claim 8, wherein the content review includes at least one of: a rating and a written review.

10. The computer-implemented method of claim 8, wherein the review is a product review.

11. The computer-implemented method of claim 1, wherein the filtering of each author is based on a measure of the respective author's ability to make discerning judgments of a product.

12. The computer-implemented method of claim 11, wherein the measure of each author's ability to make discerning judgments of a product is based on a measure of a number of products previously purchased by the user that the respective author has positively reviewed.

13. The computer-implemented method of claim 11, wherein the measure of each author's ability to make discerning judgments of a product is based on an occurrence of purchase of products by one or more individuals with an explicit relationship on a social network to the respective author, the product having been reviewed by the respective author prior to the one or more individuals' purchase of the product.

14. The computer-implemented method of claim 11, wherein the measure of each author's ability to make discerning judgments of a product is determined by an occurrence of inquiries of previously reviewed products by individuals connected on a social network to the respective author.

15. The computer-implemented method of claim 1, wherein filtering includes determining a subset of authors.

16. The computer-implemented method of claim 15, wherein the subset of authors is ordered.

17. The computer-implemented method of claim 1, wherein providing includes at least one of: displaying, presenting, transmitting, processing, and persisting.

18. A computer implemented method comprising:
receiving, at a server, data characterizing a plurality of product inquiries, each inquiry associated with a user;
filtering, using the server, the received data using social network data associated with a viewing user to create a subset of the plurality of product inquiries relevant to the viewing user; and
providing, using the server, the relevant subset;
wherein the server comprises at least one computing system having at least one data processor.

19. The computer-implemented method of claim 18, wherein each product inquiry includes a date and time the associated user requested product information.

20. The computer-implemented method of claim 19, wherein requesting product information includes scanning a barcode of the product using a mobile device.

21. The computer-implemented method of claim 18, wherein each product inquiry includes a date and time the associated user purchased the product.

22. The computer-implemented method of claim 19, wherein each product inquiry includes a date and time the associated user reviewed the product.

23. The computer-implemented method of claim 18, wherein providing includes at least one of: displaying, presenting, transmitting, processing, and persisting.
